(19) United States
(12) Patent Application Publication
(10) Pub. No.: US 2026/0211597 A1
(43) Pub. Date: Jul. 23, 2026

(54) IMAGE FORMING APPARATUS, IMAGE FORMING METHOD, AND STORAGE MEDIUM

(71) Applicant: CANON KABUSHIKI KAISHA, Tokyo (JP)

(72) Inventor: TSUYOSHI TAJIMA, Kanagawa (JP)

(21) Appl. No.: 19/419,259

(22) Filed: Dec. 15, 2025

(30) Foreign Application Priority Data
Jan. 21, 2025 (JP) 2025-008639

(51) Int. Cl. G06F 3/12

(52) U.S. Cl. CPC G06F 3/1229; G06F 3/1204; G06F 3/1285

(57) ABSTRACT

In an image forming apparatus, a delivery request for a new consumable is notified to a server, a consumable ID that is an ID of the consumable is acquired, and, in a case in which the consumable ID cannot be acquired, a consumable substitute ID including a random number is generated in place of the consumable ID, and, in notification of the delivery request, the consumable ID or the consumable substitute ID is notified.

### BACKGROUND

### Field of the Technology

The present disclosure relates to an image forming apparatus, an image forming method, and a storage medium and the like.

### Description of the Related Art

Conventionally, an automatic consumable delivery service system has been widely used, in which a server monitors remaining amounts and usage amounts of consumables in an image forming apparatus, and delivers the consumables to a user in a case in which predetermined conditions are satisfied, without requiring an operation by a user.

Japanese Patent Application Laid-Open No. 2016-139333 discloses a system that performs automatic delivery of consumables by comparing remaining amounts and usage amounts of consumables with predetermined conditions in an inventory-management system used in an image forming apparatus and the like.

In Japanese Patent Application Laid-Open No. 2016-139333, stock management is performed by using a consumable serial number, which is a unique value for identifying each individual consumable.

However, in a case in which an image forming apparatus has a configuration such that a serial number of a consumable cannot be read, the image forming apparatus cannot be registered in the stock management system disclosed in Japanese Patent Application Laid-Open No. 2016-139333, and therefore, an automatic delivery service of consumables cannot be executed. Additionally, in a model in which a serial number of a consumable cannot be read, a serial number field of a delivery request becomes blank, which may result in multiple deliveries and the like.

### SUMMARY

An image forming apparatus is provided that notifies a server of a delivery request for a new consumable, acquires consumable ID that is an ID of the consumable, generates a consumable substitute ID including a random number in place of the consumable ID in a case in which the consumable ID cannot be acquired, and notifies the consumable ID or the consumable substitute ID in the notification of the delivery request.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating an example of a network configuration in an embodiment of the present disclosure.

FIG. 2 is a block diagram illustrating an example of a configuration of an image forming apparatus in an embodiment of the present disclosure.

FIG. 3 is a block diagram illustrating an example of a configuration of a consumable-management server in an embodiment of the present disclosure.

FIG. 4 is a flowchart illustrating an example of processing for notifying a delivery request for a consumable in an embodiment of the present disclosure.

FIG. 5 is a flowchart illustrating an example of processing for obtaining a consumable substitute ID using a serial number of the image forming apparatus in a case in which a consumable serial number cannot be acquired in step S4007 of FIG. 4.

FIG. 6 is a flowchart illustrating an example of processing for obtaining a consumable substitute ID using current time in a case in which a consumable serial number cannot be acquired in step S4007 of FIG. 4.

FIG. 7 is a flowchart illustrating consumable ID acquisition in a model in which a consumable serial number can be acquired, in step S4007 of FIG. 4.

FIG. 8 is a diagram illustrating an example of a table for managing consumables in a consumable-management server in an embodiment of the present disclosure.

FIG. 9 is a flowchart illustrating an example of processing performed after a consumable-management server 102 receives a delivery notification by an information acquisition unit 308 in an embodiment of the present disclosure.

### DESCRIPTION OF THE EMBODIMENTS

Hereinafter, with reference to the accompanying drawings, favorable modes of the present disclosure will be described using Embodiments. In each diagram, the same reference signs are applied to the same members or elements, and duplicate description will be omitted or simplified.

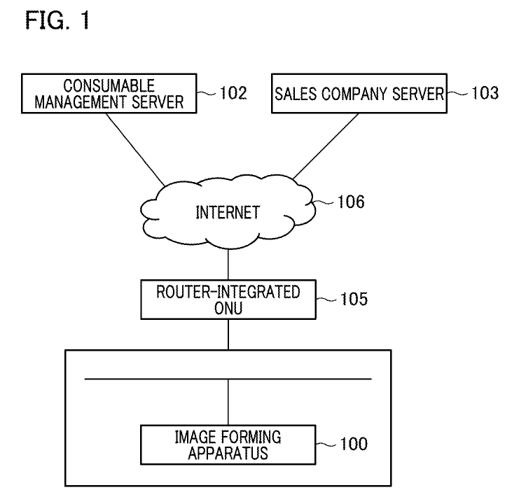

FIG. 1 is a diagram illustrating an example of a network configuration in an embodiment of the present disclosure. A reference numeral 100 denotes an image forming apparatus, which is, for example, a single function printer having a printing function. However, the present disclosure is not limited thereto. For example, the image forming apparatus may be a copying machine having a printing function and a reading device that reads an image on a document, or a multi-function peripheral (MFP) having other added functions.

Additionally, in the present embodiment, “consumables” refers to accessories that are consumed each time the image forming apparatus is operated and need to be replaced, and examples thereof include an ink tank, an ink bottle, an ink toner, and a waste ink cartridge.

A reference numeral 102 denotes a consumable-management server, a reference numeral 103 denotes a sales-company server, and a reference numeral 105 denotes a router-integrated Optical Network Unit (ONU). The router-integrated ONU 105 has a function of performing mutual conversion between an optical signal of an optical line and an electrical digital signal. The router-integrated ONU 105 in the present embodiment is connected to the Internet 106 via an optical line.

The image forming apparatus 100 is communicably connected to the Internet 106 and the consumable-management server 102 via the router-integrated ONU 105. Additionally, the consumable-management server 102 is connected to the Internet 106, includes a storage device to be described below, stores and manages, for each managed image forming apparatus, data such as start date of use of consumables, remaining-amount information, and delivery information of each consumable.

The sales-company server 103 is a management server that performs purchasing of consumables and delivers the consumables to a user registered in a automatic consumable delivery service. The sales-company server 103 manages information such as addresses of users registered in the automatic consumable delivery service.

It should be noted that although, in the present embodiment, an inkjet-method printer (printing apparatus) is exemplified as the image forming apparatus 100, the image forming apparatus may alternatively be a monochrome or full-color laser-beam (electrophotographic) printer.

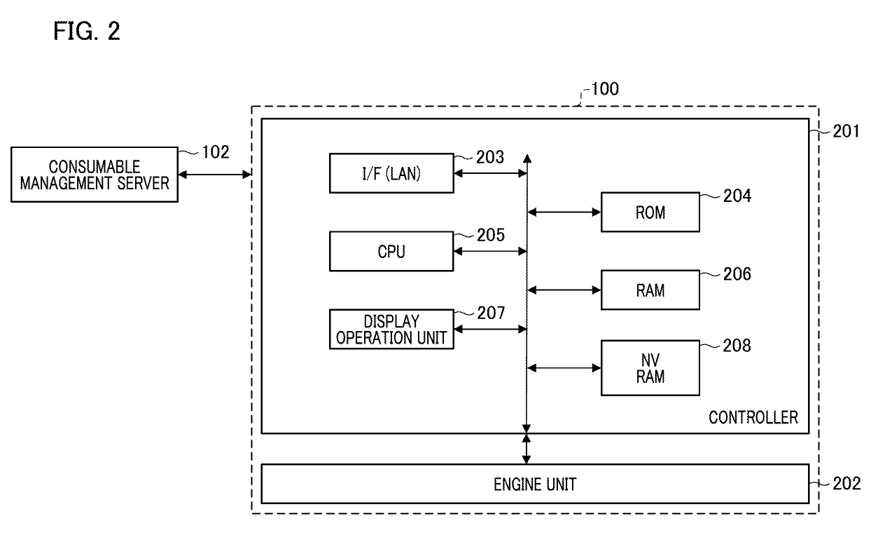

FIG. 2 is a block diagram illustrating an example of a configuration of the image forming apparatus in the embodiment of the present disclosure. The image forming apparatus 100 is controlled by a CPU 205 serving as a computer, and includes a controller 201 and an engine unit 202 for performing printing.

A ROM 204 stores control execution code (a computer program) for controlling the image forming apparatus 100. A RAM 206 temporarily stores image data for printing during control execution of the image forming apparatus 100. An NVRAM 208 is a nonvolatile memory that stores various data necessary for maintenance of the image forming apparatus 100 and information relating to images to be printed.

A display operation unit 207 includes a user interface such as an LCD, an LED, a key, or a touch panel. An I/F (LAN) unit 203 is an interface that performs connection with external devices, and functions as communication means for executing a communication step of notifying a server of a delivery request for a new consumable.

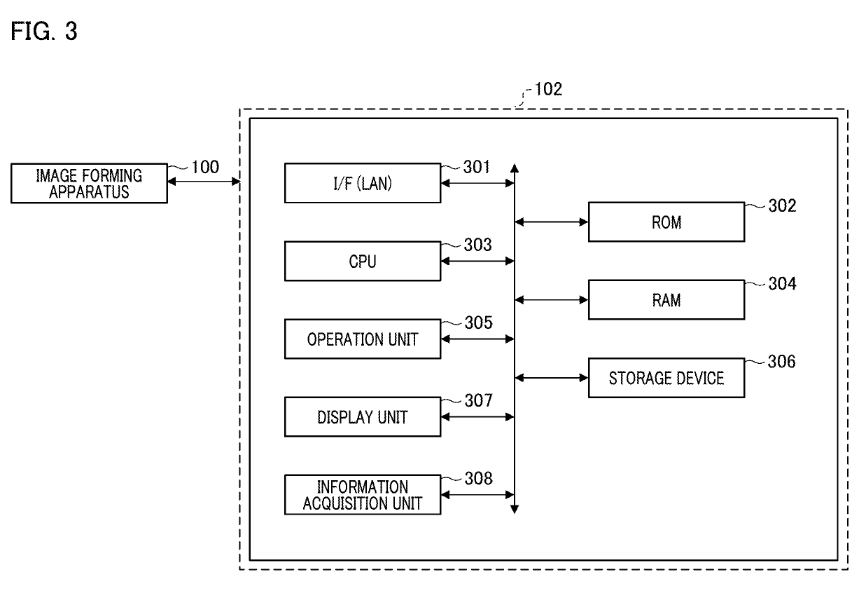

FIG. 3 is a block diagram illustrating an example of a configuration of a consumable-management server in an embodiment of the present disclosure. The consumable-management server 102 is controlled by a CPU 303 serving as a computer, and a ROM 302 is a nonvolatile memory that stores various computer programs and data operated in the consumable-management server 102.

A RAM 304 is a volatile memory that is used as a temporary work area when the CPU 303 executes various programs. An I/F (LAN) unit 301 serves as an interface with external devices, connects to the image forming apparatus 100 and the sales company server 103, and exchanges execution commands and data with the image forming apparatus 100.

An operation unit 305 is configured by a plurality of switches including a power key. A display unit 307 is configured by a plurality of LEDs. The information acquisition unit 308 communicates with the image forming apparatus 100 via the I/F (LAN) unit 301 at an arbitrary timing, and acquires information on a start date of use, a remaining amount, and an automatic delivery flag of each consumable of the image forming apparatus 100.

Such information is acquired, for example, by using command communication predefined uniquely by a manufacturer. A storage device 306 includes a plurality of hard disk drives configured in a RAID structure, and stores various data.

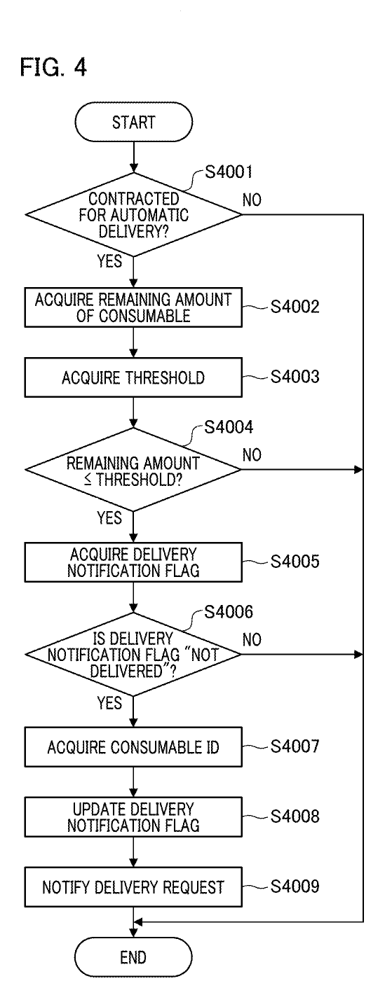

FIG. 4 is a flowchart illustrating an example of processing for notifying a delivery request for a consumable according to an embodiment of the present disclosure and illustrates an example of a processing flow in which the image forming apparatus 100 notifies the consumable-management server of a delivery request for a consumable. It should be noted that the processing flow shown in FIG. 4 is repeatedly executed at predetermined cycles.

It should be noted that operations of the respective steps in the flowchart of FIG. 4 are sequentially performed by causing a computer program stored in the ROM 204 to be loaded into the RAM 206 and executed by the CPU 205 and the like, serving as a computer of the image forming apparatus 100.

In step S4001, it is determined whether the image forming apparatus 100 is contracted for an automatic consumable delivery service. Information indicating that the image forming apparatus 100 is contracted for an automatic consumable delivery service is stored in a ROM 204. In a case in which the determination in step S4001 is “YES,” the process proceeds to step S4002, and in a case in which the determination in step S4001 is “NO,” the processing flow of FIG. 4 ends.

In step S4002, a remaining amount of the consumable is acquired. In step S4003, a threshold of the remaining amount of the consumable, which serves as a condition for notifying a delivery request to the server, is acquired. The threshold of the remaining amount of the consumable is stored in the ROM 204.

In step S4004, the current remaining amount of the consumable acquired in step S4002 and the threshold acquired in step S4003 are compared to determine whether or not the remaining amount is equal to or less than the threshold. In a case in which the determination in step S4004 is “YES”, that is, in a case in which the current remaining amount of the consumable is equal to or less than the threshold, the process proceeds to step S4005 to notify the delivery request, and in a case in which the determination in step S4004 is “NO,” the processing flow of FIG. 4 ends.

In step S4005, a delivery notification flag is acquired. That is, a delivery notification flag indicating whether or not a delivery request has already been notified is acquired for a consumable that is mounted. The delivery notification flag is stored in a nonvolatile memory that is mounted on the consumable or in the ROM 204.

In step S4006, it is determined whether or not the delivery notification flag indicates “Not Delivered.” That is, it is determined whether or not the delivery request for the mounted consumable has already been notified, based on the delivery notification flag acquired in step S4005.

In a case in which the determination in step S4006 is “YES,” that is, “Not Delivered,” the process proceeds to step S4007 to notify a delivery request, and in a case in which the determination in step S4006 is “NO,” the processing flow of FIG. 4 ends.

In step S4007, a consumable ID that identifies each individual consumable is acquired. Here, step S4007 functions as an acquisition step (acquisition means) for acquiring a consumable ID, which is an ID of the consumable.

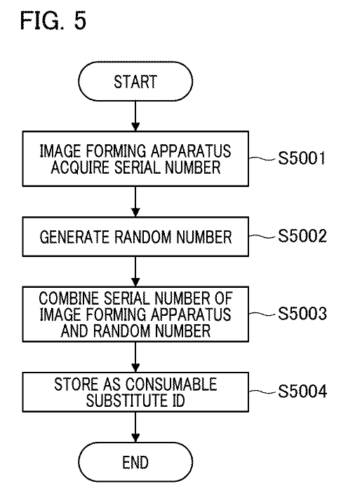

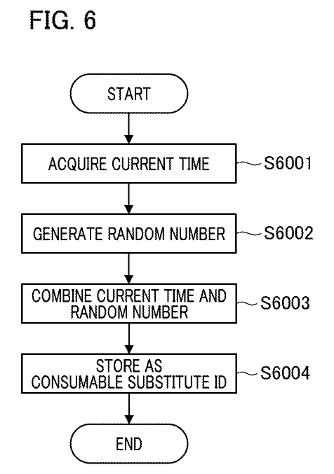

In step S4007, in a case in which the image forming apparatus has a configuration capable of reading a consumable serial number (consumable ID), the consumable serial number is regarded as the consumable ID, and in a case in which the image forming apparatus does not have such a configuration, a uniquely generated numerical value is regarded as a consumable substitute ID. Examples of generation of the consumable substitute ID will be explained in FIG. 5 and FIG. 6.

It should be noted that although, in the present embodiment, an example in which a serial number of a consumable is employed as the consumable ID is explained, the consumable ID is not limited to the serial number and may be, for example, a combination of alphanumeric characters.

In step S4008, the delivery notification flag for the consumable for which delivery notification is to be performed is updated to “Notified.” In step S4009, the delivery request is notified to the consumable-management server 102. When notifying the delivery request, the consumable ID or the consumable substitute ID, color or model number serving as information on the type of consumable, and a serial number or MAC address serving as information on the image forming apparatus are also notified as parameters.

FIG. 5 is a flowchart illustrating an example of processing for acquiring a consumable substitute ID using a serial number of the image forming apparatus in a case in which a consumable serial number cannot be acquired in step S4007 of FIG. 4.

It should be noted that operations of the respective steps in the flowchart of FIG. 5 are sequentially executed when the CPU 205 and the like, serving as a computer of the image forming apparatus 100, load a computer program stored in the ROM 204 into the RAM 206 and execute the program.

In the processing flow of FIG. 5, as one example of generation of a consumable substitute ID, a serial number of the image forming apparatus, which is a unique value for identifying the image forming apparatus, is used. That is, when generating a consumable substitute ID, the serial number of the image forming apparatus is assigned.

In step S5001, the serial number of the image forming apparatus is acquired. In step S5002, a random number used for the consumable substitute ID is generated. The number of digits of the random number is set to a value obtained by subtracting the number of digits of the image forming apparatus serial number from the number of digits of the consumable ID.

In step S5003, the serial number of the image forming apparatus acquired in step S5001 and the random number generated in step S5002 are combined. Here, as one example of a combining method, a random number is concatenated to the end of the serial number string of the image forming apparatus.

Here, step S5003 functions as a random number generation step (random number generation means) for generating, in a case in which the consumable ID cannot be acquired by the acquisition step (acquisition means), a consumable substitute ID including a random number in place of the consumable ID.

In step S5004, a value combined in step S5003 is stored as a consumable substitute ID in a memory table in place of the consumable ID. Accordingly, in the subsequent notification of the delivery request in step S4009, either the consumable ID acquired by the acquisition step (acquisition means) or the consumable substitute ID generated by the random number generation step (random number generation means) is notified.

FIG. 6 is a flowchart illustrating an example of processing for obtaining a consumable substitute ID using a current time in a case in which a consumable serial number cannot be acquired in step S4007 of FIG. 4.

It should be noted that operations of the respective steps in the flowchart of FIG. 6 are sequentially executed when the CPU 205 and the like of the image forming apparatus 100 load a computer program stored in the ROM 204 into the RAM 206 and execute the program.

In the flowchart of FIG. 6, as one example of generation of a consumable substitute ID, a current time measured by the image forming apparatus is used. That is, when generating a consumable substitute ID, the current time of the image forming apparatus is assigned.

In step S6001, a current time of the image forming apparatus is acquired. In step S6002, a random number used for the consumable substitute ID is generated. The number of digits of the random number is set to a value obtained by subtracting the number of digits of the current time from the number of digits of the consumable ID.

In step S6003, the current time acquired in step S6001 and the random number generated in step S6002 are combined. Here, as one example of a combining method, the random number is concatenated to the end of the current time. In step S6004, the value combined in step S6003 is stored in memory as a consumable substitute ID in place of the consumable ID.

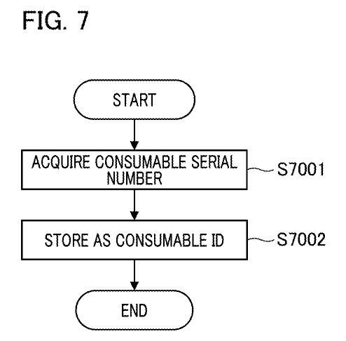

FIG. 7 is a flowchart illustrating processing for acquiring a consumable ID in a model in which a consumable serial number can be acquired in step S4007 of FIG. 4.

It should be noted that operations of the respective steps in the flowchart of FIG. 7 are sequentially executed when the CPU 205 and the like of the image forming apparatus 100 load a computer program stored in the ROM 204 into the RAM 206 and execute the program.

In step S7001, a serial number of a consumable is acquired. In step S7002, the value acquired in step S7001 is stored in a memory table as the consumable ID.

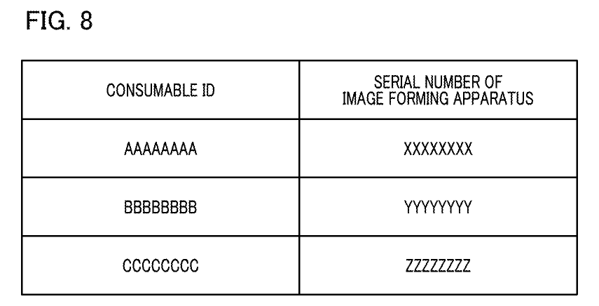

FIG. 8 is a diagram illustrating an example of a table for managing consumables in the consumable-management server according to an embodiment of the present disclosure. The table shown in FIG. 8 is stored in a ROM 302 serving as a memory. The table of the memory stores parameters of delivery requests from the image forming apparatus 100 that have been received by the information acquisition unit 308. It is to be noted that the parameters of the delivery requests include a consumable ID or a consumable substitute ID.

As shown in FIG. 8, in the present embodiment, a consumable ID or a consumable substitute ID and a serial number of the image forming apparatus are used as elements of the table. That is, in the table of FIG. 8, either the consumable ID or the consumable substitute ID is stored in the column of the consumable ID. It should be noted that it is also possible to associate and store, as elements of the table, a model number and a remaining amount of a consumable and the like.

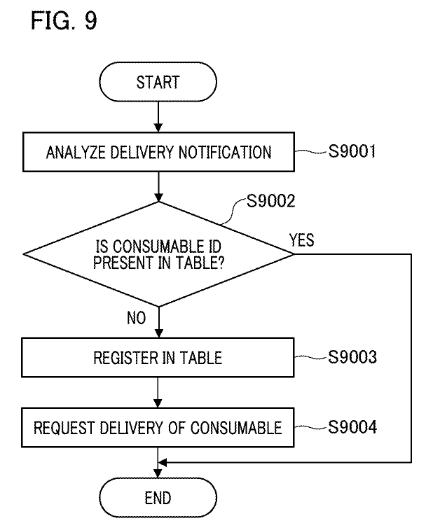

FIG. 9 is a flowchart illustrating an example of processing performed after the consumable-management server 102 receives a delivery notification by the information acquisition unit 308 according to an embodiment of the present disclosure. It should be noted that operations of the respective steps in the flowchart of FIG. 9 are sequentially executed when the CPU 303 and the like of the consumable-management server 102 load a computer program stored in the ROM 302 into the RAM 304 and execute the program.

In step S9001, the information acquisition unit 308 analyzes the delivery notification received from the image forming apparatus 100 and acquires a consumable ID and a serial number of the image forming apparatus stored as parameters by the image forming apparatus 100.

In step S9002, it is determined whether or not the consumable ID acquired in step S9001 is registered on the table stored in the ROM 302. In a case in which the determination is “NO” in step S9002, that is, in a case in which it is determined that the consumable ID is not registered in the table, the process proceeds to step S9003 to deliver the consumable to the user, or in a case in which the determination is “YES” in step S9002, the processing flow of FIG. 9 ends.

In step S9003, the consumable ID and the serial number of the image forming apparatus acquired in step S9001 are registered in a table stored in the ROM 302.

In step S9004, a delivery request is notified from the I/F (LAN) unit 301 to a sales company server so that the consumable is delivered to the user, and the processing flow of FIG. 9 ends.

As described above, in a system that performs automatic delivery of consumables using a consumable ID such as a serial number of a consumable, in a model in which the consumable ID cannot be read, the consumable ID field of the delivery request becomes blank, which may result in multiple deliveries and the like.

However, according to the present embodiment, in a case in which the consumable ID cannot be read, a substitute ID using a random number value generated inside the image forming apparatus, in place of the consumable ID, is generated. Accordingly, even in such a case as described above, automatic delivery of consumables can be appropriately performed.

Additionally, duplication of substitute IDs among different image forming apparatuses can be prevented by assigning the serial number of the image forming apparatus when generating the substitute ID. Alternatively, for example, duplication of substitute IDs generated by the same image forming apparatus can be prevented by assigning the current time when generating a substitute ID.

While the present disclosure has been described with reference to embodiments, it is to be understood that the disclosure is not limited to the disclosed embodiments. The scope of the following claims is to be accorded the broadest interpretation so as to encompass all such modifications and equivalent structures and functions.

In addition, as a part or the whole of the control according to the embodiments, a computer program realizing the function of the embodiments described above may be supplied to the image forming apparatus and the like through a network or various storage media. Then, a computer (or a CPU, an MPU, or the like) of the image forming apparatus and the like may be configured to read and execute the program. In such a case, the program and the storage medium storing the program configure the present disclosure.

In addition, the present disclosure includes those realized using at least one processor or circuit configured to perform functions of the embodiments explained above. For example, a plurality of processors may be used for distribution processing to perform functions of the embodiments explained above.

This application claims the benefit of Japanese Patent Application No. 2025-008639, filed on January 21, 2025, which is hereby incorporated by reference herein in its entirety.

What is claimed is:

1. An image forming apparatus comprising:
at least one processor; and
a memory coupled to the at least one processor, the memory storing instructions that, when executed by the at least one processor, cause the at least one processor to:
notify a server of a delivery request for a new consumable;
acquire a consumable ID that is an ID of the consumable;
generate a consumable substitute ID including a random number in place of the consumable ID in a case in which the consumable ID cannot be acquired; and
notify the consumable ID or the consumable substitute ID in the notification of the delivery request.

2. The image forming apparatus according to claim 1, wherein a serial number of the image forming apparatus is assigned during generation of the consumable substitute ID.

3. The image forming apparatus according to claim 1, wherein a current time of the image forming apparatus is assigned during generation of the consumable substitute ID.

4. An image forming method comprising:
notifying a server of a delivery request for a new consumable;
acquiring a consumable ID that is an ID of the consumable;
generating a consumable substitute ID including a random number in place of the consumable ID in a case in which the consumable ID cannot be acquired; and
notifying the consumable ID or the consumable substitute ID in the notification of the delivery request.

5. A non-transitory computer-readable storage medium storing a computer program including instructions for executing the following processes:
notifying a server of a delivery request for a new consumable;
acquiring a consumable ID that is an ID of the consumable;
generating a consumable substitute ID including a random number in place of the consumable ID in a case in which the consumable ID cannot be acquired; and
notifying the consumable ID or the consumable substitute ID in the notification of the delivery request.
